(19) United States
(12) Patent Application Publication
(10) Pub. No.: US 2019/0077592 A1
(43) Pub. Date: Mar. 14, 2019

(54) Waste Receptacle Apparatus

(71) Applicant: Gary Lawrence Johnston, Cowarts, AL (US)

(72) Inventor: Gary Lawrence Johnston, Cowarts, AL (US)

(21) Appl. No.: 15/701,464

(22) Filed: Sep. 12, 2017

(51) Int. Cl. B65F 1/14

(52) U.S. Cl. CPC B65F 1/14

(57) ABSTRACT

A Waste Receptacle Apparatus comprising a Receptacle Support Member and an inner Containment Member. The Receptacle Support Member is basically composed of three Sides Support Members pivoted coupled together such that they may form a hollow closed loop triangular-shaped container. One of the Side Support Members is composed of two Separate Support Components which are pivotally coupled to one another so that they may be folded relative to one another. The construction and attachment of the Side Support Members and Separate Support Components to one another is such that the Receptacle Support Structure may be unfolded to form the triangular shape, and also folded into a relatively flat condition. The Inner Containment member may be a conventional type garbage bag having sides and a bottom. It may be a completely separate component, or may be attached in some manner to the inside of the Side Support Members and Separate Support Components. The Inner Containment Member may be flexible and fold in conjunction with the Receptacle Support Member. A Containment Securing Member would also be utilized to keep the Receptacle Support Member fully open, and may also be utilized to keep the inner Containment Member attached to the Receptacle Support Member.

### BACKGROUND OF THE INVENTION

This invention relates to a Waste Receptacle Apparatus which is collapseable in nature so that it may be easily stored and used as needed. The apparatus comprises mainly a Receptacle Support Member and an Inner Containment Member. The Receptacle Support Member is basically composed of three Sides Support Members pivotally connected together, which form a hollow closed loop triangular-shaped container when pulled apart. One of the Side Support Members is composed of two Separate Support Components which are pivotally coupled to one another so that they may be folded against each other. This allows the Side Support Members and Separate Support Components of the Receptacle Support Structure to be folded towards one another into a relatively flat condition. The inner Containment Member is flexible in some manner and may be a separate element or may be permanently attached to the Side Support Members and Separate Support Components of the Receptacle Support Member, so that the Inner Containment Member is able to fold in conjunction with the Receptacle Support Member and stays in place during use. These features allow the apparatus to be easily folded, stored, transported, etc., and then retrieved and used as needed. A Containment Securing Member would also be utilized to keep the Receptacle Support Member fully open, prohibiting it from folding, and it may also be utilized in some instances to keep the Inner Containment Member attached to the Receptacle Support Member.

### SUMMARY AND OBJECTS OF THE INVENTION

It is the object of this invention to provide a Waste Receptacle Apparatus which may provide the user an efficient and inexpensive means for disposing waste material, such as household garbage and yard debris. The main purpose of this application is to demonstrate an apparatus which performs the stated function, and to demonstrate the many options and configurations this apparatus may take on.

Briefly stated, the apparatus that forms the basis of the invention comprises a Receptacle Support Member and an inner Containment Member. As mentioned, the Receptacle Support Member is basically composed of three upwardly extending Sides Support Members which form a hollow closed loop triangular-shaped container, with the three Side Support Members being pivotally connected together. One of the Side Support Members is composed of two Separate Support Components which are pivotally coupled to one another so that they may be folded against each other. The construction and attachment of the Side Support Members and Separate Support Components to one another is such that the Receptacle Support Structure may be folded into a relatively flat condition. The Inner Containment member may be any convention type of garbage bag having sides and a bottom. It may be a completely separate element, or may be attached in some manner to the inside of the Side Support Members and Separate Support Components of the Receptacle Support Member. The Inner Containment Member may be flexible and able to fold in conjunction with the Receptacle Support Member when attached.

The Receptacle Support Member may be composed of a material that is durable in nature, such as plastic, so that can it can be used over and over again. In this case the Inner Containment Member may be any conventional garbage bag type component that may fit within the hollow area formed by the Side Support Members and Separate Support Components. It may then be secured in place by a Containment Securing Member. In most instances, the Containment Securing Member would be mainly utilized to keep the Receptacle Support Member fully open, not allowing it to fold. The Receptacle Support Member may also be composed of a material that is bio-degradable in nature, such as cardboard. The Inner Containment Member may then be flexible and permanently attached in some manner to the Side Support Members and Separate Support Components of the Receptacle Support Member. It would fold and unfold in conjunction with the Receptacle Support Member. When the apparatus is full of debris, the entire apparatus would be disposed in a larger trash receptacle. In either instance, it is preferable that the Inner Containment Member be made of a bio-degradable material also, such as cardboard, paper, bio-degradable plastic, etc.

In order to use the apparatus, the user pulls the Side Support Members and Separate Support Components of the Receptacle Support Structure away from one another, created a generally hollow triangular-shaped structure which is open at the top and bottom. The Inner Containment Member fits within this hollow open area of the Receptacle Support Member. As mentioned previously, the Inner Containment Member may be a separate element, such as a conventional flexible garbage bag, which may be loosely attached in some manner to the Receptacle Support Member, or it may be a conventional flexible garbage bag type liner which is an actual part of the apparatus and is permanently attached to the sides. Preferably, the Inner Containment Member has the same general shape and form as the Receptacle Support Member. It would be preferable that it have a triangular bottom, with the sides also forming a triangular open shape. Otherwise, there would be a good amount of wasted material in the Inner Containment Member, which serves no purpose.

Once the Receptacle Support Member and the Inner Containment Member are pulled open, the user may then place a Containment Securing Member on the upper edges of the Side Support Members so that the Receptacle Support Member has a more rigid form. The Containment Securing Member may also be used to secure the Inner Containment Member to the Separate Support Components when it is a separate element from the Receptacle Support Member. The user may then dispose of household debris or garbage debris within the Inner Containment Member.

Once full, the Inner Containment Member may be secured and removed from the inside of the Receptacle Support Structure and placed in a larger trash receptacle, when it is a separate element. The Receptacle Support Member may then be placed into its folded condition, and may be placed along with the Containment Securing Member in a location for future reuse. In the case where the entire apparatus is disposable, the entire apparatus may be secured and placed in a larger trash receptacle. During this instance, the Containment Securing Member or Members 30 may also be considered debris, and placed within the Inner Containment Member 20 before it is secured. Preferably they would also be bio-degradable.

The Waste Receptacle Apparatus may be used in any number of applications. These include but are not limited to garbage and debris from Households, Backyard Barbecues, Picnics, Family Gatherings, and Yard Debris (leaves and sticks). The foldable concept allows the apparatus to be easily stored inside a building and used only as needed, and easily transported to other locations. The apparatus may be constructed in various sizes for different uses. For example, a small version may be available for use in bedrooms and bathrooms, a medium size version may be available for use in the kitchen, and a large size version may be available for use outdoors.

### BRIEF DESCRIPTION OF THE DRAWINGS

FIG. 1A is a front view of the Waste Receptacle Apparatus.

FIG. 1B is a top view of the Waste Receptacle Apparatus.

FIG. 1C is a side view of the Waste Receptacle Apparatus.

FIG. 2A is a front view of the Receptacle Support Member of the Waste Receptacle Apparatus.

FIG. 2B is a top view of the Receptacle Support Member of the Waste Receptacle Apparatus.

FIG. 2C is a side view of the Receptacle Support Member of the Waste Receptacle Apparatus.

FIG. 2D is a top view of the Receptacle Support Member of the Waste Receptacle Apparatus, demonstrating its folding capabilities.

FIG. 3A is a front view of the Inner Containment Member of the Waste Receptacle Apparatus.

FIG. 38 is a top view of the Inner Containment Member of the Waste Receptacle Apparatus.

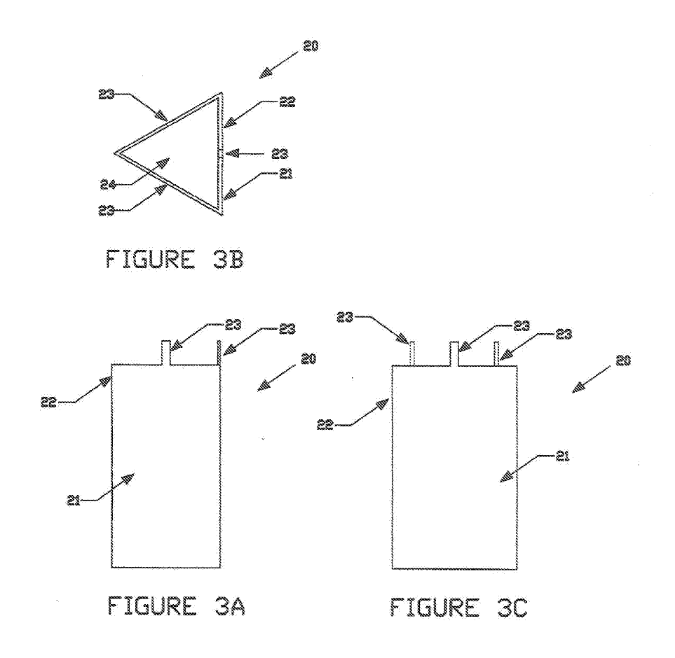

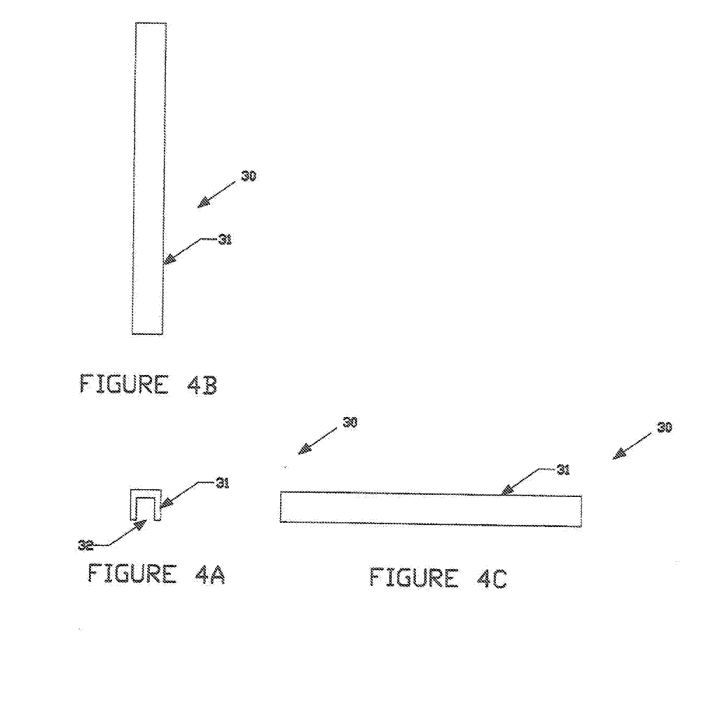

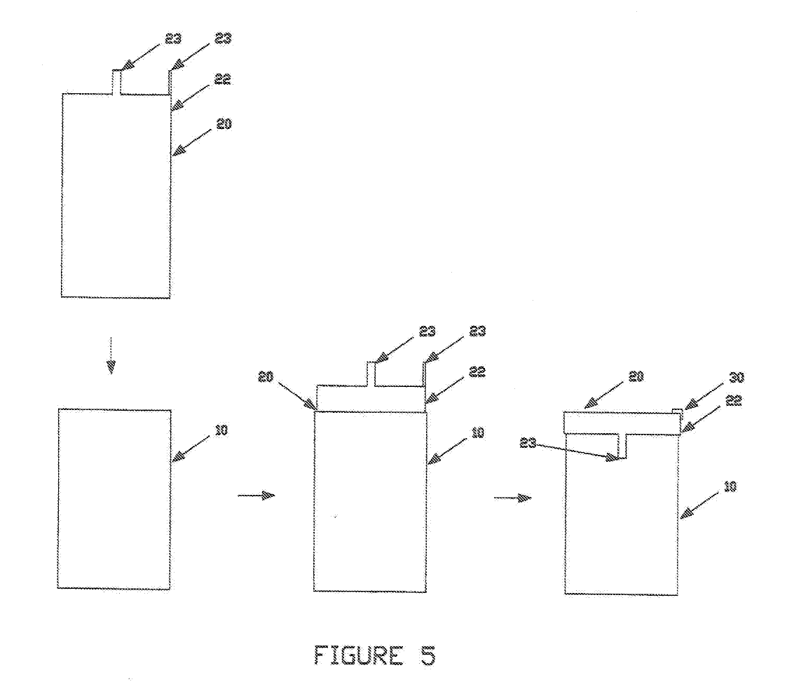

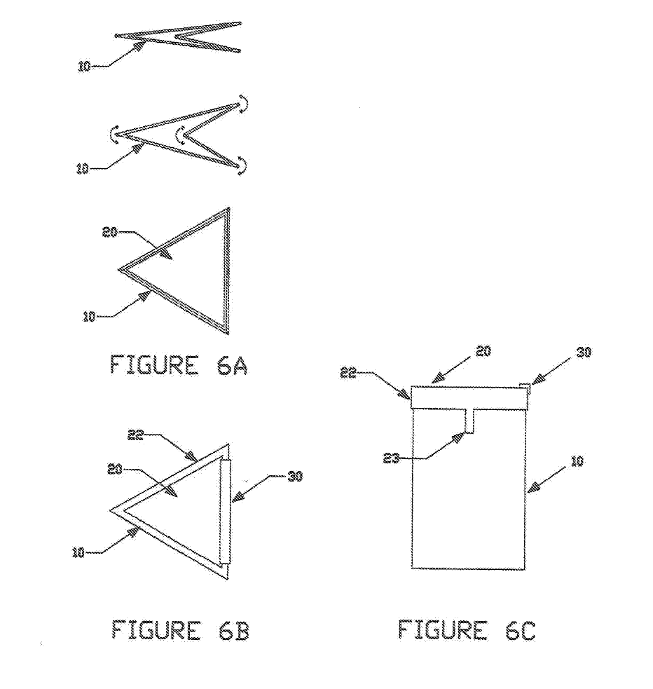

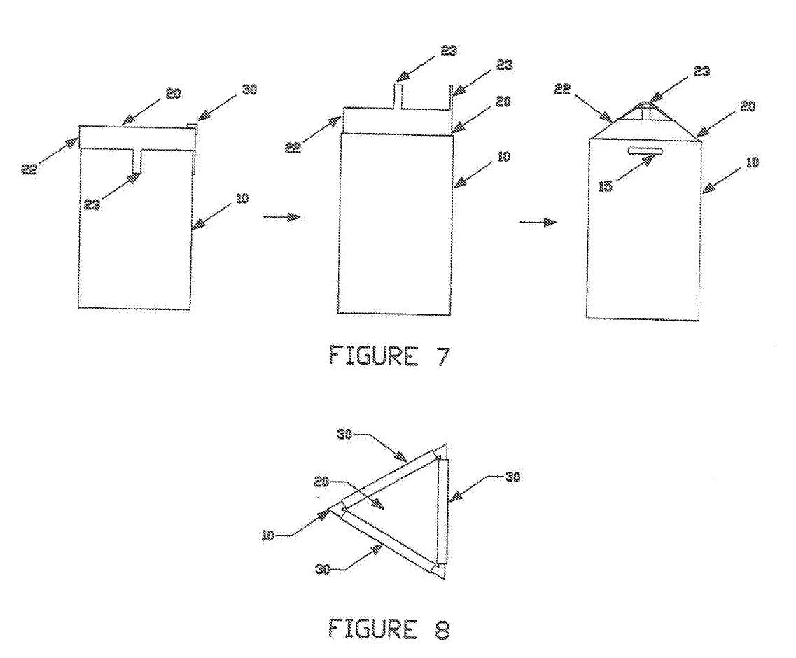

FIG. 3C is a side view of the Inner Containment Member of the Waste Receptacle Apparatus.

FIG. 4A is a front view of the Containment Securing Member of the Waste Receptacle Apparatus.

FIG. 48 is a top view of the Containment Securing Member of the Waste Receptacle Apparatus.

FIG. 4C is a side view of the Containment Securing Member of the Waste Receptacle Apparatus.

FIG. 5 is side views of the Waste Receptacle Apparatus demonstrating how an Inner Containment Member may be placed within the Receptacle Support Member, how the upper portions of the inner Containment Member may fold over the top of the Receptacle Support Structure, and how the Containment Securing Member may be used to create a more rigid structure of the Receptacle Support Structure and secure the Inner Containment Member.

FIG. 6A is top views of the Waste Receptacle Apparatus demonstrating how it may be unfolded from a folded condition into its normal usable condition.

FIG. 6B is a top view of the Waste Receptacle Apparatus in its normal usable condition, and demonstrates how the upper portions of the Inner Containment Member may fold over the top of the Receptacle Support Member, and how the Containment Securing Member may be used to create a more rigid structure of the Receptacle Support Member and also secure the Inner Containment Member.

FIG. 6C is a side view of the Waste Receptacle Apparatus in its normal usable condition, and demonstrates how the upper portions of the Inner Containment Member may fold over the top of the Receptacle Support Structure, and how the Containment Securing Member may be used to create a more rigid structure of the Receptacle Support Member and also secure the inner containment member.

FIG. 7 is side views of the Waste Receptacle Apparatus, demonstrating how the various components of the Inner Containment Member may be secured together for proper disposal.

FIG. 8 is a top view of the Waste Receptacle Apparatus demonstrating the apparatus having multiple Containment Securing Members for creating a more rigid structure form, and for securing the upper portions of the Inner Containment Member to the upper edges of the Receptacle Support Structure.

### DETAILED DESCRIPTION OF THE PREFERRED EMBODIMENT

Before explaining in detail the present invention, it is to be understood that the invention is not limited in its application to the details of construction or arrangement of parts illustrated in the accompanying drawings, since the invention is capable of other embodiments and of being practiced or carried out in various ways. Also, it is to be understood that the phraseology and terminology employed herein is for the purpose of description, and not limitation.

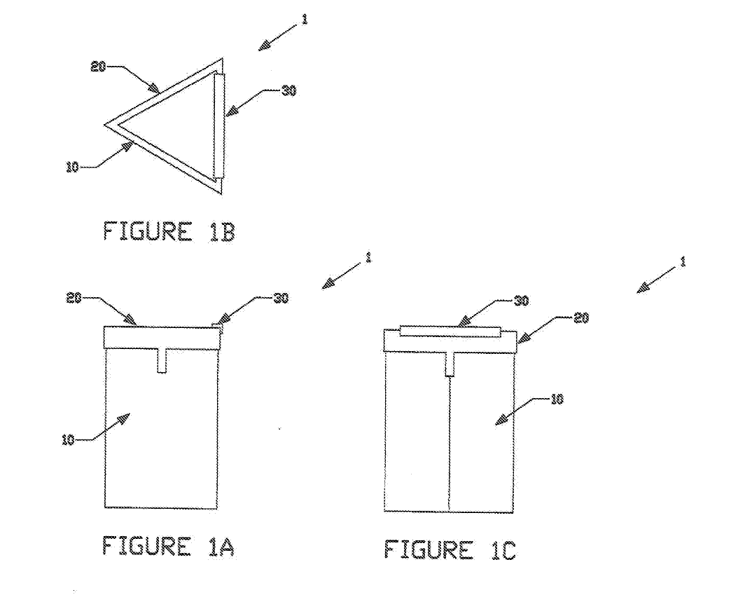

As best can be seen by references to the drawings, and in particular to FIGS. 1A-1C, the Waste Receptacle Apparatus that forms the basis of the present invention is designated generally by the reference numeral 1, and comprises a Receptacle Support Member 10 having an Inner Containment Member 20, which together form a generally triangular-shaped apparatus. The Inner Containment Member 20 is contained within the Receptacle Support Member 10 in such a manner that the apparatus may be used to hold garbage and debris. A Containment Securing Member 30 may also be part of the apparatus. It may be used to create a more rigid structure form of the Receptacle Support Member 10, and may also be used in some instances to secure the Inner Containment Member 20 to the Receptacle Support Member 10.

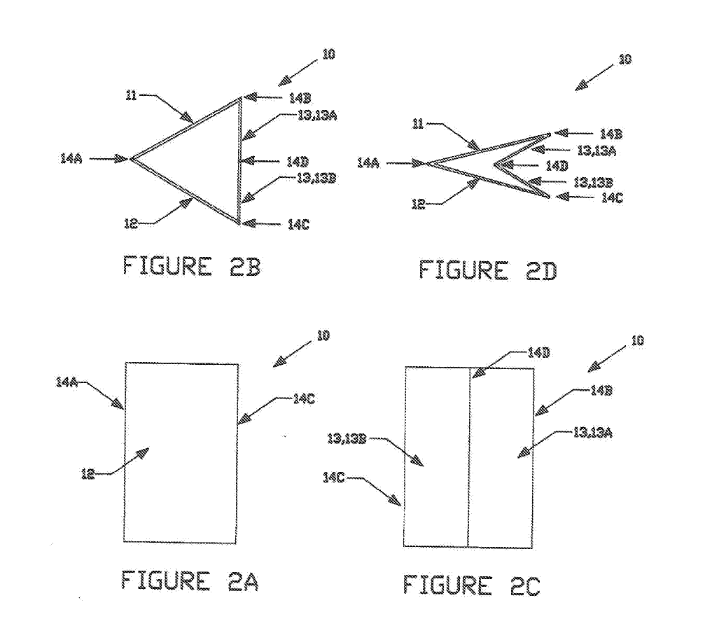

As may be seen in FIGS. 2A-2C, the Receptacle Support Member 10 has Side Support Members 11, 12, and 13, which are pivotally connected together at locations 14A, 14B, and 14C, so that they may form a generally hollow triangular shape. Side Support Member 13 is comprised of two Separate Support Components 13A and 13B which are also pivotally connected together at location 14D.

FIG. 2D demonstrates how the pivoting sides of the Receptacle Support Member 10 allow the apparatus to be folded into a relatively flat condition. As shown, the inside areas of Side Support Members 11 and 12 may be folded towards one another, while the outside areas of Separate Support Components 13A and 13B may also be folded towards one another. The inside area of Separate Support Component 13A may be folded towards Side Support Member 11, while the inside area of Separate Support Component 13B may be folded towards Side Support Member 12. The reverse is true when the apparatus is unfolded.

The pivoting connection between Side Support Members 11, 12, 13, and Separate Support Components 13A and 13B may be any common hinge type of connection found in any number of products. The connections may be anything from a plastic or metal hinge connection found in doors, to a paper hinge connection found in folding boxes. The more elaborate hinge might be utilized with an apparatus having a changeable Inner Containment Member 20 as a separate element, and a less elaborate hinge connection might be utilized when the apparatus is meant to be disposed of in its entirety.

FIGS. 3A, 3B, and 3C demonstrate the Inner Containment Member 20. Inner Containment Member 20 has at least three side components 21. Each side components 21 has an upper portion 22 with a securing component 23. Inner Containment Member 20 is open in the upward direction, and also has a bottom component 24 which connects the bottoms of side components 21 so that garbage and debris may be placed and contained within. Preferably, the Inner Containment Member 20 has the same general triangular shape and form as the inside of the Receptacle Support Member. It serves the purpose of a garbage bag, and may be made of any convention types of materials commonly found in garbage bags, such as flexible plastic, cardboard, and paper.

As shown in FIGS. 4A, 4B, and 4C, a Containment Securing Member 30 may also be part of the Waste Receptacle Apparatus. It may have an elongated, inverted U-shaped rigid structure 31. The underneath open area 32 of the member is sized to fit over the top edges of the Separate Support Components of the Receptacle Support Member to create a more rigid structure form. A Containment Securing Member 30 may also be used to secure the Inner Containment Member 20 to the Side Support Members of the Receptacle Support Member, in which case the open area 32 would be also sized to fit over the Side Support Members of the Receptacle Support Member. It may proved beneficial to also have a Containment Securing Member which fits onto the bottom edges of the Separate Support Components to provide for an even sturdier rigid form structure.

FIG. 5 demonstrates how the Inner Containment Member 20 may be a separate element which is placed within the Receptacle Support Member 10, after the Receptacle Support Member 10 has been unfolded. The Inner Containment Member 20 is open in the upward direction, and also has a bottom component which connects the bottoms of the side components so that garbage and debris may be placed and contained within. The figure also demonstrates how the upper portions 22 and securing components 23 of the Inner Containment Member 20 may be folded over the top edges of the Receptacle Support Member 10. The figure also demonstrates how the Containment Securing Member 30 may be placed over the Separate Support Components of the Receptacle Support Member 10 to create a more rigid form structure.

FIGS. 6A, 6B, and 6C demonstrate a Waste Receptacle Apparatus which may have an Inner Containment Member 20 which is already permanently attached to the Receptacle Support Member 10. Again, the Inner Containment Member 20 is open in the upward direction, and also has a bottom component which connects the bottoms of the side components so that garbage and debris may be placed and contained within. The sides of the Inner Containment Member may be permanently attached to the insides of the Receptacle Support Member 10 using any type of conventional adhesive. They fold and unfold in conjunction with the Receptacle Support Member 10. FIG. 6A shows how the apparatus may be unfolded to create the generally triangular shape. FIG. 6B demonstrates the apparatus with the Upper Portions 22 and Securing Components 23 of the Inner Containment Member 20 folded over the top edges of the Receptacle Support Member 10, along with the placement of the Containment Securing Member 30 over the Separate Support Components of the Receptacle Support Member 10 to create a more rigid structure. FIGS. 6B and 6C both show different views of the apparatus when it has been place in condition for normal use. When the Waste Receptacle Apparatus is in its initial stored and unfolded condition, as shown in FIG. 6A, the Upper Portions 23 and Securing Components 24 of the Inner Containment Member 20 are folded within. The Containment Securing Member or Members 30 may also be stored initially within Inner Containment Member 20.

FIG. 7 demonstrates how the apparatus may be configured for disposal after its use. Once the Inner Containment Member 20 is full of debris, the Upper Portions 22 and Securing Components 23 of the Inner Containment Member may be pulled upward. The Securing Components 23 may be tied together in some manner to secure and contain the debris within the Inner Containment Member 20. If the Inner Containment Member 20 is a separate component from the Receptacle Support Member 10, then it may be removed from within the hollow portion of the Receptacle Support Member 10 and disposed. The Receptacle Support Member 10 may then be folded back into a relatively flat condition for reuse, along with the Containment Securing Member 30.

If the Inner Containment Member 20 is permanently attached or adhered to the inside of the Receptacle Support Member 10, then the Securing Components 23 may be tied together in some manner to secure the debris inside, and the entire apparatus disposed. During this instance, the Containment Securing Member or Members 30 may be considered debris. It would be removed and placed within the Inner Containment Member 20 before it is secured together. In this instance, it is preferable that the entire Waste Receptacle Apparatus be constructed of bio-degradable material. FIG. 7 also demonstrates a slot opening member 15 which may be incorporated into at least two of the Side Support Members, so that a person may place their fingers into the slots to more easily pick up the apparatus.

FIG. 8 demonstrates the apparatus utilizing multiple Containment Securing Members 30, which not only create a more sturdy and rigid structure form, but also better secure the Inner Containment Member 20 to the Receptacle Support Member 10. This feature may prove beneficial when the Inner Containment Member 20 is both a separate element from the Receptacle Support Member and when it is attached or adhered to the Receptacle Support Member. They would keep the upper portions of the Inner Containment Member 20 folded into place.

Many variations of the numerical display apparatus exist, along with the configurations described above. While it will be apparent that the preferred embodiment of the invention herein disclosed is well calculated to fulfill the objects above stated, it will be appreciated that the invention is susceptible to modification, variation, and change without departing from the proper scope or fair meaning of the subjoined claims.

I claim:

1. A Waste Receptacle Apparatus comprising;
a receptacle support member having a first side support member, a second side support member, and a third side support member which extend in the general upward direction, said third side support member having a first side component and a second side component, said first side support member pivotally coupled to said second side support member and to said first side component of said third side support member, said second side support member pivotally couple to said first side support member and to said second side component of said third side support member, and said first side component and second side component of said third side support member pivotally coupled together;
an inner containment member which extends in the general upward, said inner containment member having a bottom and sides components, with an area between which is open in the general upward direction, said bottom and said side components of said inner containment member being placed within said hollow portion of said receptacle support member with said side components being supported by said first, second, and third sides of said receptacle support member;
whereby said first and second side support members may be folded towards and away from one another, said first and second separate support components may be folded towards and away from one another, said first separate support component may be folded towards and away from said first side support member, said second separate support component may be folded towards and away from said second side support member, such that said receptacle support member may be unfolded into a generally triangular shape to receive said inner containment member, and such that said receptacle support member may be folded into a generally flat condition when not in use.

2. The Waste Receptacle Apparatus as claimed in claim 1 further comprising a containment securing member, said first side component and said second side component of said third side support member of said receptacle support member having top edges over which said containment securing member may be placed, said containment securing member being used to keep said first side component and said second side component in general alignment with one another so that said receptacle support member may maintain a rigid triangular shape during use.

3. The Waste Receptacle Apparatus as claimed in claim 1 further comprising a containment securing member, said first side component and said second side component of said third side support member of said receptacle support member having bottom edges over which said containment securing member may be placed, said containment securing member being used to keep said first side component and said second side component in general alignment with one another so that said receptacle support member may maintain a rigid triangular shape during use.

4. The Waste Receptacle Apparatus as claimed in claim 1, said inner containment member being a separate member from said receptacle support member.

5. The Waste Receptacle Apparatus as claimed in claim 1, said inner containment member being securely attached to said receptacle support member.

6. The Waste Receptacle Apparatus as claimed in claim 1, said inner containment member having an upper area which extends above said receptacle support member, said upper area of said inner containment member being foldable over said first, second, and third side support members of said receptacle support member, said upper area also having securing components attached.

7. The Waste Receptacle Apparatus as claimed in claim 6, further comprising multiple containment securing members, said first, second, and third side support members of said receptacle support member having top edges over which said containment securing members may be placed to secure said upper areas of said inner containment member to said receptacle support member.

8. A Waste Receptacle Apparatus comprising;
a receptacle support member having a first side support member, a second side support member, and a third side support member which extend in the general upward direction, said third side support member having a first side component and a second side component, said first side support member pivotally coupled to said second side support member and to said first side component of said third side support member, said second side support member pivotally couple to said first side support member and to said second side component of said third side support member, and said first side component and second side component of said third side support member pivotally coupled together;
an inner containment member which extends in die general upward, said inner containment member having a bottom and sides components, with an area between which is open in the general upward direction, said bottom and said side components of said inner containment member being placed within said hollow portion of said receptacle support member with said side components being supported by said first, second, and third sides of said receptacle support member;
a containment securing member, said first side component and said second side component of said third side support member of said receptacle support member having top edges over which said containment securing member may be placed, said containment securing member being used to keep said first side component and said second side component in general alignment with one another so that said receptacle support member may maintain a rigid triangular shape during use;
whereby said first and second side support members may be folded towards and away from one another, said first and second separate support components may be folded towards and away from one another, said first separate support component may be folded towards and away from said first side support member, said second separate support component may be folded towards and away from said second side support member, such that said receptacle support member may be unfolded into a generally triangular shape to receive said inner containment member, and such that said receptacle support member may be folded into a generally flat condition when not in use.

9. The Waste Receptacle Apparatus as claimed in claim 8 further comprising a containment securing member, said first side component and said second side component of said third side support member of said receptacle support member having bottom edges over which said containment securing member may be placed, said containment securing member being used to keep said first side component and said second side component in general alignment with one another so that said receptacle support member may maintain a rigid triangular shape during use.

10. The Waste Receptacle Apparatus as claimed in claim 8, said inner containment member being a separate member from said receptacle support member.

11. The Waste Receptacle Apparatus as claimed in claim 8, said inner containment member being securely attached to said receptacle support member.

12. The Waste Receptacle Apparatus as claimed in claim 8, said inner containment member having an upper area which extends above said receptacle support member, said upper area of said inner containment member being foldable over said first, second, and third side support members of said receptacle support member, said upper area having securing components attached.

13. The Waste Receptacle Apparatus as claimed in claim 12, further comprising multiple containment securing members, said first, second, and third de support members of said receptacle support member having top edges over which said containment securing members may be placed to secure said upper areas of said inner containment member to said receptacle support member.
